(19) United States
(12) Patent Application Publication
(10) Pub. No.: US 2022/0268098 A1
(43) Pub. Date: Aug. 25, 2022

(54) SCREEN FRAME ELEMENT

(71) Applicant: Panther Global Pty Ltd, Wheelers Hill (AU)

(72) Inventor: Edward Donald ALLEN, Wheelers Hill (AU)

(21) Appl. No.: 17/304,781

(22) Filed: Jun. 25, 2021

(30) Foreign Application Priority Data
Feb. 22, 2021 (AU) 2021900467

(51) Int. Cl. E06B 9/52; E06B 3/06

(52) U.S. Cl. CPC E06B 9/52; E06B 3/06

(57) ABSTRACT

A screen frame element, such as for a security door or window, includes a base; first and second flanges defining a channel and first and second opposing support surfaces; an anchoring member connected to the second flange by a deformable pivot region and extending into the channel at an acute angle relative to the first support surface; and a seat at an inner edge of the first supporting surface substantially opposite the pivot region. The anchoring member is configured to engage the folded edge of a screen sheet, such that, when the screen sheet is drawn away from the base with sufficient force to overcome a yield strength of the pivot region, the anchoring member is configured to rotate about the pivot region to grip part of the screen sheet between the anchoring member and the seat.

### INCORPORATION BY REFERENCE

This application claims priority to Australian Patent App. No. 2021900467, filed February 22, 2021, which is hereby incorporated by reference in its entirety for all purposes.

### BACKGROUND

### Technical Field

Embodiments relate generally to screen frame elements, screen frame kits, screen frames and associated methods of assembly. Some embodiments relate to a screen frame element for a security screen, such as for a security door or window, for example.

### Background

Conventional security screen doors and windows typically include a steel mesh mounted in a screen frame with screws. However, stress is concentrated at the screws when force is applied to the mesh screen, which can lead to failure of the mesh where at the locations of the screws.

One solution is described in Australian Patent AU 2010241512 B2, owned by the applicant of the present application, the contents of which is incorporated herein.

It is desired to address or ameliorate one or more shortcomings or disadvantages associated with existing screen frames and screen frame elements, or to at least provide a useful alternative.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a screen frame element comprising an elongate body defining:
a base;
a first flange extending away from the base and defining a first support surface;
a second flange extending away from the base and defining a second support surface opposite the first support surface;
a channel defined between the first and second flanges, the channel extending substantially the length of the body and configured to receive a folded edge of a screen sheet;
an anchoring member extending at least partially along and in parallel with the channel, the anchoring member being connected to the second flange by a deformable pivot region and extending into the channel towards the base and away from the second support surface at an acute angle relative to the first support surface; and
a seat defined by part of the first flange at an inner edge of the first supporting surface substantially opposite the pivot region,
wherein the anchoring member is configured to engage the folded edge of the screen sheet when inserted in the channel and over the anchoring member, such that
when the screen sheet is drawn away from the base, the anchoring member resists withdrawal of the folded edge of the screen sheet from the channel, and
when the screen sheet is drawn away from the base with sufficient force to overcome a yield strength of the pivot region, with the force on the screen sheet being transmitted to the anchoring member by the folded edge of the screen sheet, the anchoring member is configured to rotate about the pivot region and towards the seat to resist removal of the folded edge of the screen sheet from the channel by gripping part of the screen sheet between the anchoring member and the seat.

Some embodiments relate to a screen frame element comprising an elongate body defining:
a base;
a first flange extending away from the base and defining a first support surface;
a second flange extending away from the base and defining a second support surface opposite the first support surface;
a channel defined between the first and second flanges, the channel extending substantially the length of the body and configured to receive a folded edge of a screen sheet;
an anchoring member extending at least partially along and in parallel with the channel, the anchoring member being connected to the second flange by a deformable pivot region and extending into the channel towards the base and away from the second support surface at an acute angle of less than 60 degrees relative to the first support surface; and
a seat defined by part of the first flange,
wherein the anchoring member is configured to engage the folded edge of the screen sheet when inserted in the channel and over the anchoring member, such that
when the screen sheet is drawn away from the base, the anchoring member resists withdrawal of the folded edge of the screen sheet from the channel, and
when the screen sheet is drawn away from the base with sufficient force to overcome a yield strength of the pivot region, with the force on the screen sheet being transmitted to the anchoring member by the folded edge of the screen sheet, the anchoring member is configured to rotate about the pivot region and towards the seat to resist removal of the folded edge of the screen sheet from the channel by gripping part of the screen sheet between the anchoring member and the seat.

In some embodiments, the initial angle of the anchoring member, relative to the first support surface, may be less than 60 degrees, less than 50 degrees, less than 45 degrees, less than 40 degrees, greater than 20 degrees, greater than 25 degrees, greater than 30 degrees, in the range of 25 degrees to 50 degrees, 25 degrees to 45 degrees, 30 degrees to 40 degrees, about 35 degrees or about 38 degrees, for example.

The seat may be located within 2 mm of an imaginary plane extending through the pivot region perpendicular to the first support surface and a direction along the length of the channel. The seat may be located directly opposite the pivot region.

A width of the anchoring member, defined between the pivot region and a free edge of the anchoring member, may be less than a distance between the pivot region and the seat. The anchoring member may comprise a substantially rectangular strip. The anchoring member may extend the entire length (or substantially the entire length) of the channel. A thickness of the anchoring member may be greater than a thickness of the pivot region.

The first and second flanges, the base and the anchoring member may define a constant cross-sectional profile along substantially the entire length of the channel. The first and second flanges, the base and the anchoring member may be integrally formed.

Some embodiments relate to a screen frame kit, comprising: one or more screen frame elements according to anyone of the described embodiments; and a screen sheet defining one or more folded edges configured to engage the anchoring member of each of the one or more screen frame elements.

The kit may further comprise one or more elongate wedges, each configured to be inserted between the screen sheet and the second support surface of each of the one or more screen frame elements to clamp the screen sheet in the channel of each of the one or more screen frame elements.

The kit may further comprise one or more isolators configured to isolate the screen sheet from each of the one or more screen frame elements.

Some embodiments relate to a method of assembling a screen using the kit of any one of the described embodiments, the method comprising: inserting one of the folded edges of the screen sheet into the channel of one of the screen frame elements with part of the folded edge located between the anchoring member and the base of the screen frame element.

The method may further comprise inserting one of the wedges between the screen sheet and the second support surface of the screen frame element.

The method may further comprise inserting one of the isolators into the channel of the screen frame element prior to inserting the folded edge of the screen sheet into the screen frame element.

Some embodiments relate to a screen formed according to any one of the disclosed methods.

Some embodiments relate to a screen comprising a screen frame element according to any one the disclosed embodiments.

Some embodiments relate to a door comprising a screen according to any one of the disclosed embodiments.

Some embodiments relate to a window comprising a screen according to any one of the disclosed embodiments.

Some embodiments relate to any combination of any two or more of the steps, features, integers, structures or elements disclosed herein or indicated in the specification of this application.

### BRIEF DESCRIPTION OF THE DRAWINGS

Embodiments will now be described, for exemplary purposes only, with reference to the drawings, in which:

FIG. 1A is a perspective view of a screen frame element, according to some embodiments;

FIG. 1B is a cross-sectional view of the screen frame element of FIG. 1A illustrating initial and deformed configurations;

FIG. 1C is a cross-sectional view of the screen frame element of FIG. 1A with illustrative dimensions;

FIG. 1D is a cross-sectional view of a first flange of the screen frame element of FIG. 1A with illustrative dimensions;

FIG. 1E is a cross-sectional view of a second flange and anchoring member of the screen frame element of FIG. 1A with illustrative dimensions;

FIG. 2A is a cross-sectional view of a screen frame kit including the screen frame element of FIG. 1A, according to some embodiments, in a disassembled configuration;

FIG. 2B is a cross-sectional view of the screen frame kit of FIG. 2A in an assembled configuration;

FIG. 2C is a cross-sectional view of the assembled screen frame kit of FIG. 2B in a deformed configuration, illustrating operation of the screen frame element;

FIG. 3A is a cross-sectional view of a screen frame element, according to some embodiments, illustrating initial and deformed configurations with illustrative dimensions;

FIG. 3B is a cross-sectional view illustrating a base section of the screen frame element of FIG. 3A with illustrative dimensions;

FIG. 3C is a cross-sectional view illustrating a first flange of the screen frame element of FIG. 3A with illustrative dimensions;

FIG. 3D is a cross-sectional view illustrating a second flange and anchoring element of the screen frame element of FIG. 3A with illustrative dimensions;

FIG. 4A is a schematic view of a screen, according to some embodiments, in a disassembled configuration;

FIG. 4B is a schematic view of the screen of FIG. 4A in an assembled configuration;

FIG. 5A is a cross-sectional view of a window mounting structure including the screen frame element of FIG. 1A;

FIG. 5B is a perspective view of the window mounting structure of FIG. 5A; and

FIG. 6 is a cross-sectional view of an alternative screen frame element.

### DETAILED DESCRIPTION

Embodiments relate generally to screen frame elements, screen frame kits, screen frames and associated methods of assembly. Some embodiments relate to a screen frame element for a security screen, such as for a security door or window, for example.

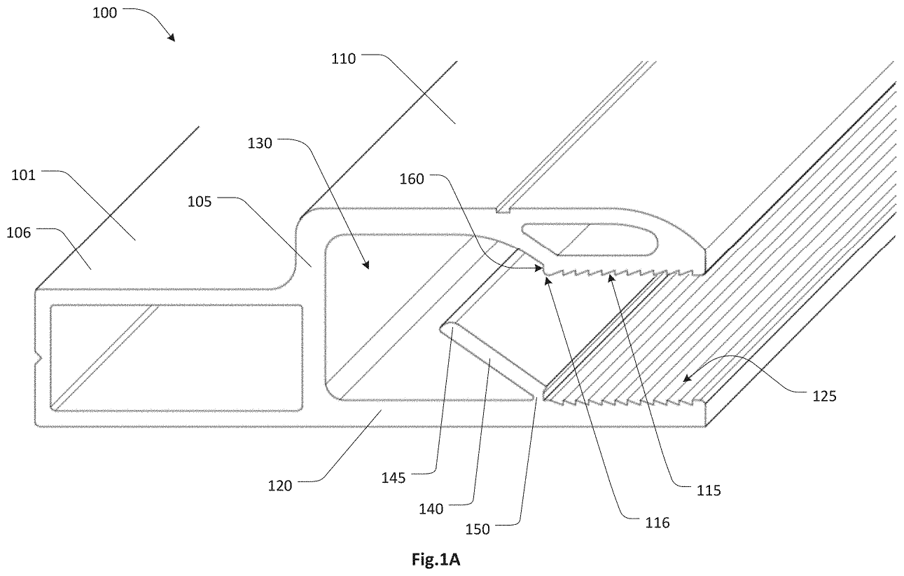

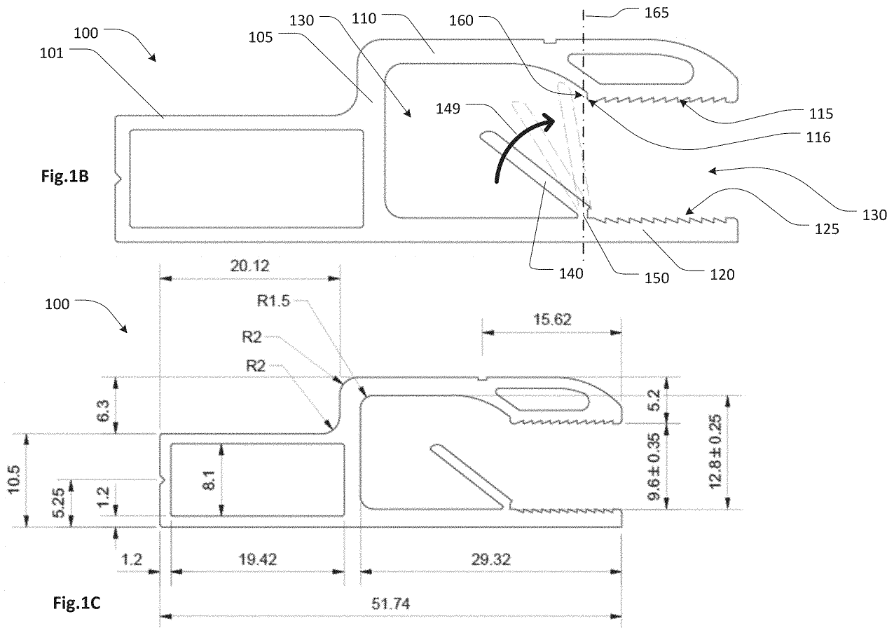

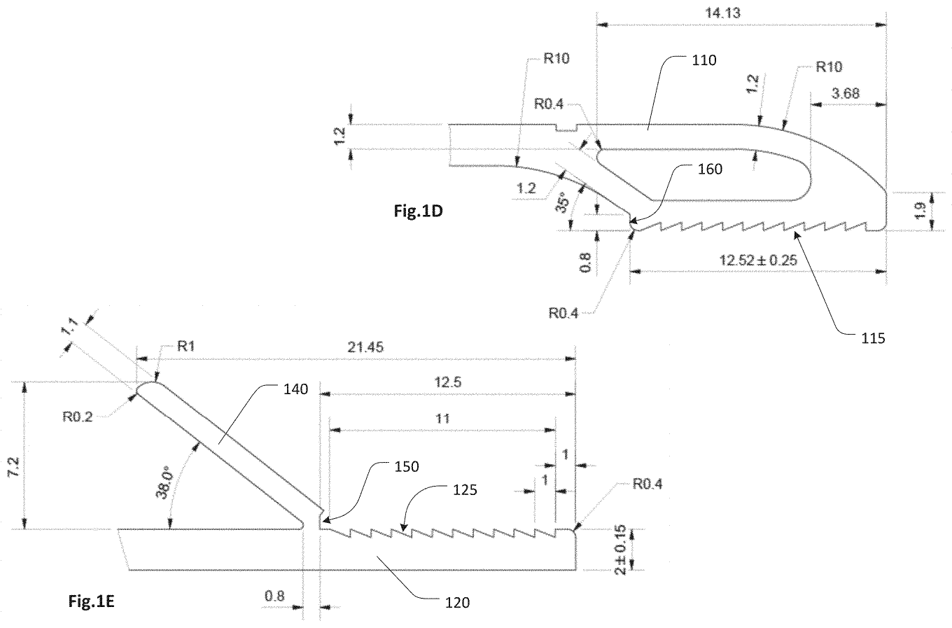

Referring to FIGS. 1A to 1E, a screen frame element 100 is shown according to some embodiments. The screen frame element 100 may be assembled with other screen frame elements to form a screen frame and assist in supporting a screen sheet to form a screen. For example, the screen frame may be configured to support a security screen mesh for a security door or window.

The screen frame element 100 comprises an elongate body 101 defining: a base 105; a first flange 110 extending away from the base and defining a first support surface 115; and a second flange 120 extending away from the base 105 and defining a second support surface 125 opposite the first support surface 115. The first and second flanges 110, 120 may also be considered as first and second limbs when viewed in cross-section, as shown in FIGS. 1B and 1C.

A channel 130 is defined between the first and second flanges 110, 120. The channel 130 may extend substantially (or entirely) the length of the body 101 and be configured to receive a folded edge of a screen sheet. For example, a security screen mesh.

The body 101 further defines an anchoring member 140 extending at least partially along and in parallel with the channel 130. In some embodiments, the anchoring member 140 may extend the entire length of the channel 130 or substantially the entire length of the channel 130.

The anchoring member 140 is connected to the second flange 120 by a deformable pivot region 150 and extends into the channel 130 towards the base 105 and away from the second support surface 125 at an acute angle relative to the first support surface 115. The anchoring member 140 may be considered as a leg member when viewed in cross-section, as shown in FIGS. 1B and 1C, and may be referred to as a sacrificial leg member or jamming member.

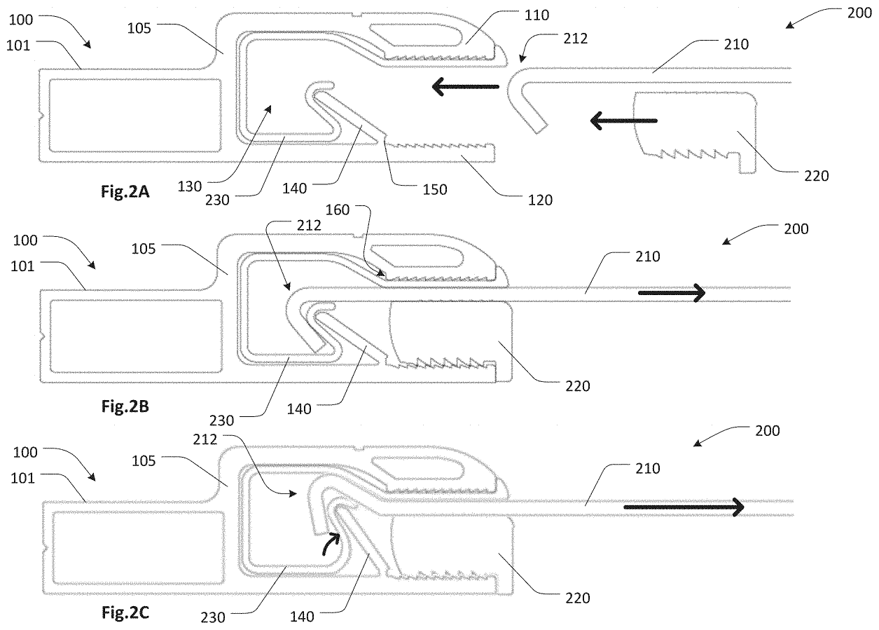

The anchoring member 140 is configured to engage the folded edge of the screen sheet when inserted in the channel 130 and over the anchoring member 140. This is described in further detail below in relation to FIGS. 2A to 2C.

As shown in FIG. 1A, in some embodiments, the anchoring member 140 may comprise a generally rectangular strip with one edge connected to the pivot region 150 and one free edge 145. The free edge 145 may be partly rounded or chamfered to enhance force transmission between the anchoring member 140 and the screen sheet when mounted in the screen frame element 100.

The body 101 further defines a seat 160 defined by part of the first flange 110 at an inner edge 116 of the first supporting surface 115 substantially opposite the pivot region 150. That is, the seat 160 may not be directly opposite the pivot region 150, but may be close to an imaginary line opposite the pivot region 150.

For example, the seat 160 may be located within a certain distance of an imaginary plane 165 (see FIG. 1B) extending through the pivot region 150 perpendicular to the first support surface 115 and a direction along the length of the channel 130, such as within 2 mm, 1 mm, or 0.5 mm of the plane 165. In some embodiments, the seat 160 may be located directly opposite the pivot region 150.

The pivot region 150 is configured such that a sufficient moment applied to the anchoring member 140 (sufficient to overcome the yield strength of the pivot region 150), will cause the anchoring member 140 to rotate about the pivot region 150 while deforming the pivot region 150, as shown in FIG. 1B and indicated by the arrow 149.

The anchoring member 140 may be configured to withstand the expected forces applied to it without deforming significantly, while the pivot region 150 may be narrower so as to yield and plastically deform to allow rotation of the anchoring member 140 when sufficient force is applied to the free edge 145. Some suitable dimensions and materials are described below, according to some embodiments, for exemplary purposes.

In some embodiments, the base 105 may simply comprise a plate connecting the first and second flanges 110, 120. The base 105 may be connected to another supporting structure to mount a screen in a door or window, for example.

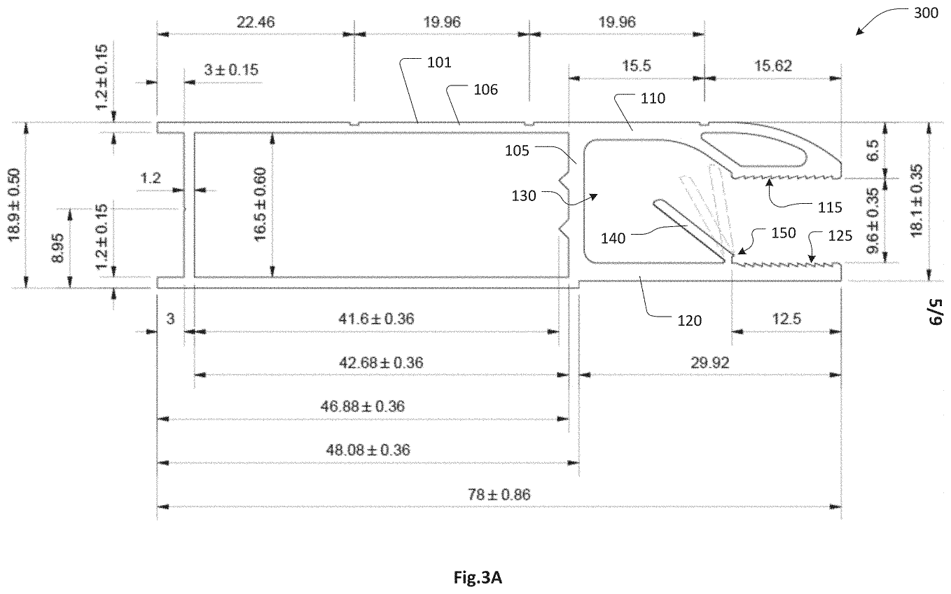

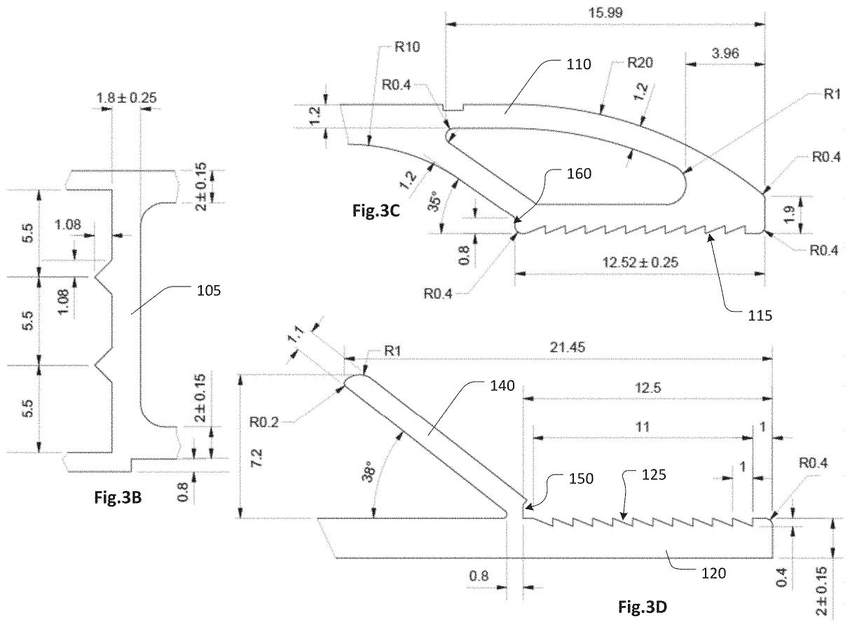

In some embodiments, the base 105 may include a stiffening member 106, as shown in FIG. 1A, such as a box section, for example. Different bases 105 including different stiffening members 106 may be included depending on the application. For example, different profiles are shown in FIGS. 1A and 3A for comparison. Either profile may be used for any suitable application, including doors and windows or any other form of screen. For example, screen element 100 may form part of a security window screen, while screen element 300 (shown in FIG. 3A) may form part of a security door screen.

In some embodiments, the first and second flanges 110, 120, the base 105 and the anchoring member 140 may extend in parallel with each other along substantially the entire length of the body 101. In some embodiments, the first and second flanges 110, 120, the base 105 and the anchoring member 140 may define a constant cross-sectional profile along substantially the entire length of the channel.

The first and second support surfaces 115, 125 may be parallel or substantially parallel with each other. In some embodiments, the second support surface 125 may be slightly angled with respect to the first support surface 115.

In some embodiments, one or both of the first and second support surfaces 115, 125 may include a surface variation to enhance static friction with other components. For example, the surface variations may include ridges or serrations as shown in the drawings.

In some embodiments, the first and second flanges 110, 120, the base 105 and the anchoring member 140 may integrally formed. For example, the entire body 101 may be formed as an extrusion. The extruded body 101 may then be cut to suitable lengths for a given application, and optionally mitred for corner joints.

Referring to FIGS. 2A to 2C, a screen frame kit 200 is shown, according to some examples, which illustrates operation of the anchoring member 140. The screen frame kit 200 comprises one or more screen frame elements according to any one of the embodiments described herein (e.g., element 100 as shown in FIGS. 2A to 2C), and a screen sheet 210 defining one or more folded edges 212 configured to engage the anchoring member 140 of each of the one or more screen frame elements 100.

One screen edge 212 and screen frame element 100 are shown in FIGS. 2A to 2C, but a screen sheet may be provided with two, three or four folded edges 212 and corresponding frame elements 100 to be mounted in and connected to form a rectangular screen, for example.

FIGS. 2A to 2C also illustrate a method of assembling a screen with the components shown. That is, inserting one of the folded edges 212 of the screen sheet 200 into the channel 130 of one of the screen frame elements 100 with part of the folded edge 212 located between the anchoring member 140 and the base 105 of the screen frame element 100.

In some embodiments, the folded edge 212 may be inserted into the channel 130 in the direction indicated by the arrow in FIG. 2A. In some embodiments (e.g., if the folded edge 212 is too large to pass over the anchoring member 140), the folded edge 212 may be inserted axially into and along the channel 130 from an open end of the screen frame element 100.

In some embodiments, the kit 200 may further comprise one or more elongate wedges 220, each configured to be inserted between the screen sheet 210 and the second support surface 120 of each of the one or more screen frame elements 100 to clamp the screen sheet 210 in the channel 130 of each of the one or more screen frame elements 100. For example, the wedge 220 may be formed of a resilient material such as rubber (further examples discussed below).

The assembly method may further comprise inserting one of the wedges 220 between the screen sheet 210 and the second support surface 120 of the screen frame element.

The kit 200 may also include one or more isolators 230 configured to isolate the screen sheet 200 from each of the one or more screen frame elements 100. The isolator 230 may line part of the channel to reduce or avoid contact between the screen frame element 100 and the screen sheet 210. This may reduce or avoid galvanic corrosion between the screen frame element 100 and the screen sheet 210 if they are formed of different metals. The assembly method may further comprise inserting one of the isolators 230 into the channel of the screen frame element 100 prior to inserting the folded edge 212 of the screen sheet 210 into the screen frame element 100. Each isolator 230 may be inserted axially into and along the channel 130 from an open end of the screen frame element 100.

FIG. 2B shows the folded edge 212 of the screen sheet 210 mounted in the channel 130 of the screen frame element 100. When the screen sheet 210 is drawn away from the base 105 (i.e., in the direction indicated by the arrow in FIG. 2B), the anchoring member 140 resists withdrawal of the folded edge 212 of the screen sheet 210 from the channel 130. The folded edge 212 catches on the anchoring member 140 to resist removal.

The wedge 220 urges part of the screen sheet 210 against the first support surface 115 to create static friction between the screen sheet 210 and the first support surface 115, and also between the screen sheet 210 and the wedge 220, and between the wedge 220 and the second support surface 125. This static friction also contributes to resisting removal of the screen sheet 210 from the channel 130.

When an isolator 230 is installed in the channel 130, part of the isolator 230 may be disposed between the first support surface 115 and the screen sheet 210, in which case there may be static friction created between the isolator 230 and the screen sheet 210, and also between the isolator 230 and the first support surface 115. Part of the isolator 230 may be disposed between the anchoring member 140 and the folded edge 212 of the screen sheet 210.

When the screen sheet 210 is drawn away from the base 105 (i.e., in the direction indicated by the arrows in FIGS. 2B and 2C) with sufficient force to overcome a yield strength of the pivot region 150, with the force on the screen sheet 210 being transmitted to the anchoring member 140 by the folded edge 212 of the screen sheet 210 (with the isolator 230 pressed between them, if installed), the anchoring member 140 is configured to rotate about the pivot region 150 and towards the seat 160 to resist removal of the folded edge 212 of the screen sheet 210 from the channel 130 by gripping part of the screen sheet 210 between the anchoring member 140 and the seat 160.

For example, the screen frame element 100 may be used to support a security screen mesh 210 in a security door. The screen sheet 210 may be put under tension by a potential intruder kicking or otherwise impacting the screen sheet 210, thereby drawing the screen sheet 210 away from the screen frame element 100 and rotating the anchoring member 140 towards the seat 160 thereby gripping the screen sheet 210 between the anchoring member 140 and the seat 160.

As illustrated in FIG. 2C, the screen sheet 210 (and part of the isolator 230, if installed) is sandwiched between the anchoring member 140 and the seat 160, which creates static friction between the screen sheet 210 and the anchoring member 140, and also between the screen sheet 210 and the seat 160. If an isolator 230 is installed, static friction is created between the seat 160 and the isolator 230, between the isolator 230 and the screen sheet 210 (on both sides of the screen sheet 210 depending on arrangement of the isolator 230), and between the isolator 230 and the anchoring member 140.

Rotation of the anchoring member 140 towards the seat 160 may also further urge the screen sheet 210 against the first support surface 115 (with isolator 230 disposed therebetween, if installed), which further increases the static friction between them. The rotation of the anchoring member 140 may also act to deform the screen sheet 210 by bending it over the seat 160, as shown in FIG. 2C. This depends on the dimensions of the screen frame element 100 and the properties of the screen sheet 210 (e.g., thickness and stiffness). In some embodiments, the screen sheet 210 may not be deformed by the anchoring member 140 and seat 160.

FIG. 2C also illustrates that once the pivot region 150 is deformed and the anchoring member 140 has rotated towards the seat 160, the anchoring member 140 still acts as an anchor supporting the folded edge 212 of the screen sheet 210 to resist removal. Further tension applied to the screen sheet 210 to draw it away from the base 105 acts to increase the rotating moment urging the anchoring member 140 towards the seat 160, thereby further increasing the static friction between the components.

Further tension applied to the screen sheet 210 will further increase the static friction resisting removal until the forces overcome the strength of the components, and either the folded edge 212 of the screen sheet unfolds and pulls through, or the pivot region 150 fails and the anchoring member 140 breaks away from the second flange 120. These features can be optimised for a given application depending on the characteristics of a given screen sheet (e.g., material, mesh type, thickness, stiffness) to provide a stronger screen frame compared with conventional screw fastened screens, as the screen sheet is supported evenly across substantially the entire edge 212 of the screen sheet 210, thus avoiding localised stress concentrations associated with screw fastening points in conventional security screens.

A previous iteration of this design described in AU 2010241512 B2, owned by the applicant of the present application, included a similar anchoring member or sacrificial leg member, but it was set closer to the base (further away from the seat) with a steeper initial angle.

With further design optimisation, as shown in the present application, it was found that locating the seat 160 nearer to the pivot region 150 enhanced the effect of pressing the screen sheet 210 between the anchoring member 140 and the seat 160, thereby increasing the force required to remove the screen sheet 210 from the screen frame element 100.

It was also discovered that angling the anchoring member 140 further back towards the base 105 for the initial configuration enhanced resistance to removal of the screen sheet 210.

In the previous design iteration, the initial angle of the leg member relative to the support surfaces was approximately 80 degrees. It was found that reducing this initial angle below 80 degrees enhanced resistance to removal of the screen sheet 210.

In the design of the present application, in some embodiments, the initial angle of the anchoring member 140, relative to the first support surface 115, may be less than 60 degrees, less than 50 degrees, less than 45 degrees, less than 40 degrees, greater than 20 degrees, greater than 25 degrees, greater than 30 degrees, in the range of 25 degrees to 50 degrees, 25 degrees to 45 degrees, 30 degrees to 40 degrees, about 35 degrees or about 38 degrees, for example.

Referring to FIG. 3A, a screen frame element 300 is shown according to some embodiments, with illustrative dimensions, for exemplary purposes only. The screen frame element 300 may include any of the features described above in relation to screen frame element 100, and like features are indicated with like reference numerals. For example, the screen frame element 300 may form part of a screen for a security door.

Further details of the base 105 are shown in FIG. 3B; further details of the first flange 110 and seat 160 are shown in FIG. 3C and further details of the anchoring member 140 and pivot region 150 are shown in FIG. 3D.

Some of the dimensions are discussed in further detail below, for exemplary purposes only. These dimensions may be suitable for any alternative embodiments of the screen frame element, including the screen frame element 100 described in relation to FIGS. 1A to 1E, as well as the screen frame element 300 described in relation to FIGS. 3A to 3D.

A width of the anchoring member 140, defined between the pivot region 150 the free edge 145 of the anchoring member, may be less than a distance between the pivot region 150 and the seat 160.

Depending on other dimensions of the screen element 100, 300 and the screen sheet 210 intended for use with the screen element 100, 300, the width of the anchoring member 140 may be less than 100%, less than 95%, less than 90%, less than 80%, greater than 70%, greater than 80% or greater than 90% of the distance between the pivot region 150 and the seat 160.

For example, the width of the anchoring member 140 may be in the range of 5 mm to 15 mm, 6 mm to 12 mm, 7 mm to 11 mm, 8.5 mm to 10.5 mm, 9 mm to 10 mm, or about 9.3 mm.

A thickness of the anchoring member 140 may be in the range of 0.5 mm to 3 mm, 0.8 mm to 2.5 mm, 1 mm to 2 mm, 1 mm to 1.5 mm or about 1.2 mm, depending on the strength and stiffness of the chosen material.

The thickness of the anchoring member 140 may be greater than a thickness of the pivot region 150. For example, the pivot region 150 may narrow to a thickness in the range of 0.5 mm to 1 mm, 0.7 mm to 0.9 mm or about 0.8 mm.

The screen frame element 100, 300 may be formed of any suitable material, including metals, metal alloys, aluminium, aluminium alloys, such as aluminium alloy 6063 or 6061, tempered alloys, such as Al 6063-T5 or Al 6063-T6, or AL6061-T5.

The dimensions illustrated in FIGS. 3A to 3C for screen frame element 300 are suitable for Aluminium alloy 6063 T5-T6 with an ultimate tensile strength in the range of about 170 MPa to 250 MPa, and a yield strength in the range of about 150 MPa to 230 MPa. However, dimensions may be varied in different embodiments and different materials may be used.

The wedge 220 may be formed of any suitable resilient material, such as a polymer, elastomeric material, or rubber, such as EPDM rubber, for example.

The isolator 230 may be formed of any suitable electrically isolating material, including polymers such as PVC, or E58uPVC, for example.

The screen sheet 210 may be formed of a perforated sheet, expanded metal sheet or woven mesh formed of a metal, metal alloy, steel or aluminium alloy, for such as, 0.8 mm or 1.6 mm DVA mesh formed of aluminium, aluminium alloy, or galvanised steel, for example. The screen sheet 210 may also comprise a surface coating, such as a powder coat finish, for example.

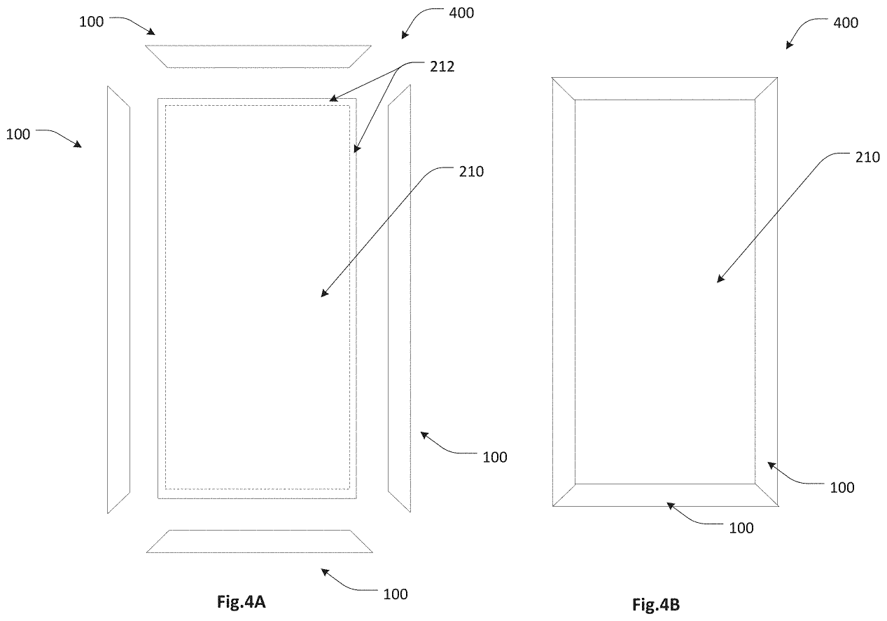

Referring to FIGS. 4A and 4B a screen 400 is shown, according to some embodiments. The screen 400 may comprise a screen sheet 210 and a plurality (e.g. 4) screen frame elements 100 (or 300), as shown in a disassembled state in FIG. 4A.

The screen sheet 210 is shown with four folded edges 212 configured to be inserted in each of the corresponding screen frame elements 100. In some embodiments, one of the edges (e.g., the top edge) may not be folded, so as to facilitate assembly.

The screen frame elements 100 may be slid over the folded edges 212 (optionally with isolators 230 pre-placed in the channel 130) with each folded edge 212 extending over the corresponding anchoring member 140 of each screen frame element 100. Wedges 220 may then be inserted, as discussed above and shown in FIG. 2A and 2B to urge the screen sheet 210 against the first support surface 110 of each screen frame element 100 (with optional isolators 230 disposed therebetween).

The screen frame elements 100 may then be fixed to each other at the corners to form the screen 400, as shown in FIG. 4B.

The screen 400 may form part of a security door or window. For example, the screen frame elements 100 may form the stiles and top and bottom rails of a door.

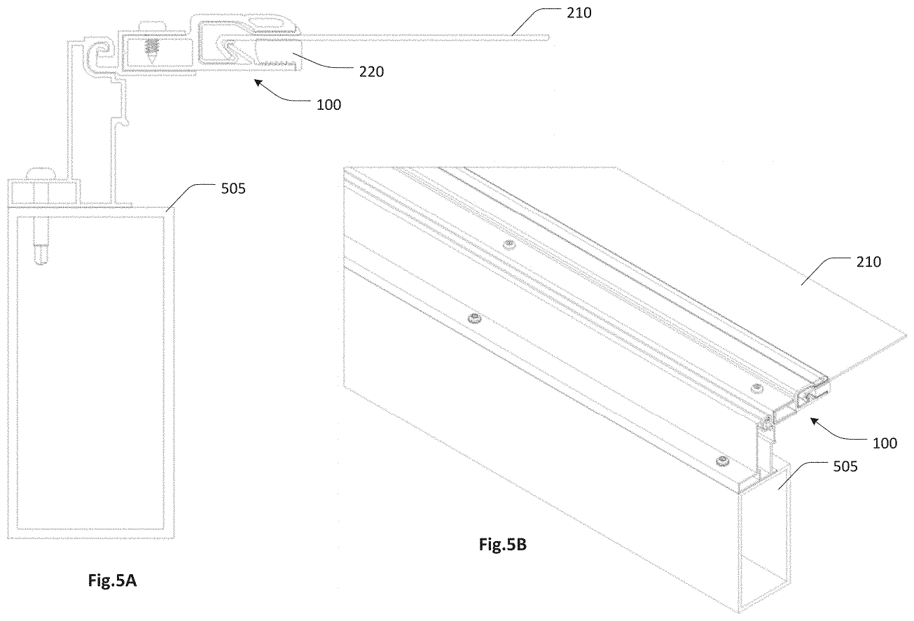

In some embodiments, the screen frame elements may be connected to further structures to be mounted as a door or window, such as a hinge and door jam. FIGS. 5A and 5B illustrate how screen element 100 may be connected to a window frame 505 to mount the screen 400 to cover a window.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

### Comparative Test

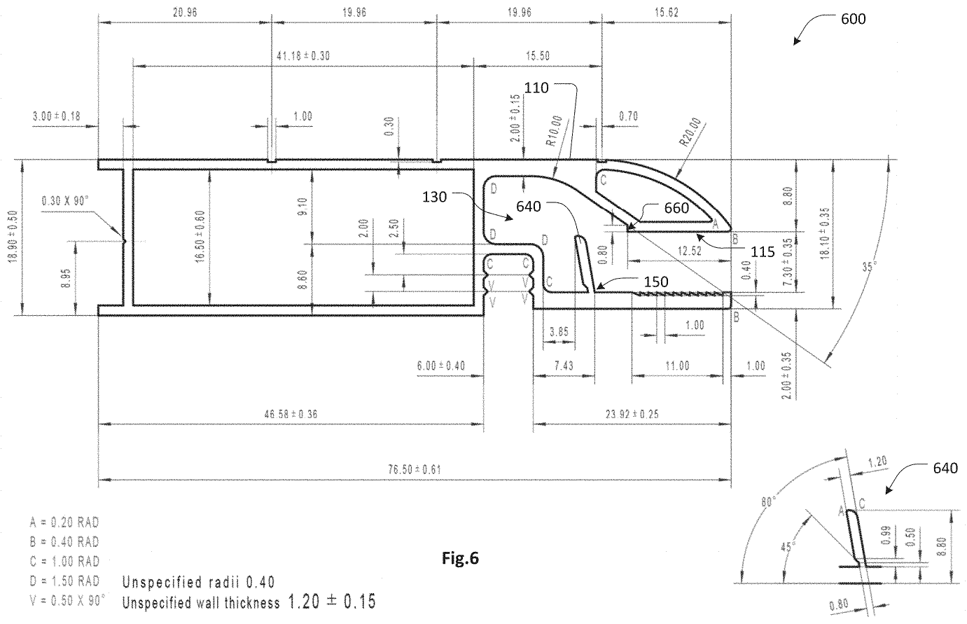

In order to demonstrate the advantages of the screen frame elements 100, 300, and the configuration of the anchoring member 140 in particular, comparative test results are set out below comparing the configuration described above in relation to screen frame element 300 to that of another design iteration of a screen frame element 600 shown in FIG. 6. It should be noted that the screen frame element 600 shown in FIG. 6 has not previously been published and does not constitute prior art in relation to the present application, but shares some features with the extrusion described in Australian Patent AU 2010241512 B2.

The screen frame element 600 defines similar features to those described in relation to screen frame element 300 above, including an anchoring member 640 and seat 660, which are similar to anchoring member 140 and seat 160 of screen frame element 300. Like features are indicated with like reference numerals. However, the anchoring member 640 and seat 600 are provided in a different configuration in the screen frame element 600 compared with the anchoring member 140 and seat 160 of screen frame element 300.

As set out above, in screen frame element 300, the seat 160 (defined by part of the first flange 110 at an inner edge of the first supporting surface 115) is substantially opposite the pivot region 150 of the anchoring member 140. In contrast, the anchoring member 640 of the screen element 600 shown in FIG. 6 is set back deeper into the channel 130, away from the seat 660 (at the inner edge of the first supporting surface 115), and the pivot region 150 of the anchoring member 640 is not disposed substantially opposite the seat 660.

It should also be noted that the initial angle of the anchoring member 640 relative to the first supporting surface 115 of the screen frame element 600 is 80°, whereas the initial angle of the anchoring member 140 of screen frame element 300 is shown as 38° in the drawings, (though the initial angle may be different in other embodiments as discussed in relation to screen frame elements 100, 300 above).

In order to compare the performance of screen frame element 300 with the performance of screen frame element 600, screens were fabricated using the screen frame elements as described in relation to FIGS. 4A and 4B.

A first screen was fabricated using lengths of screen frame element 600 formed of Aluminium alloy 6063-T6 with 0.9 mm mesh formed of 316 stainless steel with 1.5 mm spacing and 1.5 mm aperture size to form a screen having a height of 2000 mm and width of 790 mm.

A second screen was fabricated using lengths of screen frame element 300 formed of Aluminium alloy 6063-T6 with 0.8 mm mesh formed of 316 stainless steel with 1.5 mm spacing and 1.5 mm aperture size to form a screen having a height of 2120 mm and width of 1000 mm.

The first and second screens were each subjected to dynamic impact tests in accordance with Australian Standard AS 5039-2008, by fixing the screen to a support frame and arranging a pendulum with a weight to impact the mesh of the screen to simulate a forced entry attempt (for example, kicking or hitting a screen door with a tool). The testing procedure was as follows:
1. Attach specimen to the support frame with the specimen positioned such that the impactor strikes the outside face of the screen door.
2. Check the mass of the impactor.
3. The impactor is attached to a suspension cable and suspended such that the side of the bag rests against the face of the infill and the cable is vertical. The length of the suspension cable is adjusted such that the center of gravity of the impactor is aligned with a point 600+/−25 mm from the bottom edge of the test door frame and 250+/−25 mm from the edge of the specimen.
4. The impactor is lifted until the drop height distance (calculated from equations (1-6) below) is reached and the following is observed:
(a) Line of swing is perpendicular to the plane of the infill;
(b) the suspension cable is taut; and
(c) the bridle is not angling the impactor through contact at top edge of same.
5. The impactor is released such that it is not impeded or jerked and the swing is clean. The impactor is prevented from hitting a second time after the first impact.
6. The test sample is examined for signs of damage i.e. cracks, gaps or breakage.
7. Steps 4 to 6 were repeated for a total of 5 impacts to satisfy the Australian Standard, and then with further impacts at higher impact energy to test beyond the standard.
8. Record any deformation or fracture of the test specimen infill material and the size of the largest hole in the infill material. Record any deformation or fracture of the test specimen infill material to framing section interface and the size of the largest hole formed at that interface.

In order to pass the test, the infill material (including the infill to framing section interface) shall not be breached in any way; no part of the edge of the security screen door or window grille shall have deflected to the extent that the gap between the security screen door or window grille and the door or window frame is greater than 150 mm, perpendicular to the door or window frame, after the dynamic impact test has been completed.

The weight (W) of Impact bag was checked and was measured as 44.120 Kilograms. The measured height (hi) from the finished ground level to the impact point is 650 mm.

Drop height (h) of Impact bag for 100 Joule blow is calculated using the following equation:

h=10204/W=10204/44.120=231.28 mm (1)

The total height (H) the impact bag will be raised to from the finished ground level is determined to be:

H=h+hᵢ=231.28+650=881.28 mm (2)

Drop height (h) of Impact bag for 200 Joule blow is calculated using the following equation:

h=2*10204/W=2*10204/44.120=462.55 mm (3)

The total height (H) the impact bag will be raised to from the finished ground level is determined to be:

H=h+hᵢ=462.55+650=1112.55 mm (4)

Drop height (h) of Impact bag for 300 Joule blow is calculated using the following equation:

h=3*10204/W=3*10204/44.120=693.83 mm (5)

The total height (H) the impact bag will be raised to from the finished ground level is determined to be:

H=h+hᵢ=693.83+650=1343.83 mm (6)

The results of the tests are provided in Table 1 below, showing the deflection of the deformed mesh at the impact point after each impact, the deflection being measured perpendicular to the plane of the undeformed mesh. The measurement labelled “standard” is the measured deflection prior to any impacts. Impacts 1 to 8 each had an impact energy of 100 J; impacts 9 to 13 each had an impact energy of 200 J; and impacts 14 to 20 each had an impact energy of 300 J.

TABLE 1

| | Screen 1 | Screen 2 |
|---|---|---|
| Standard | 20 mm | 19 mm |
| Impact 1 | 27 mm | 30 mm |
| Impact 2 | 31 mm | 37 mm |
| Impact 3 | 35 mm | 43 mm |
| Impact 4 | 36 mm | 43 mm |
| Impact 5 | 40 mm | 45 mm |
| Impact 6 | 42 mm | 47 mm |
| Impact 7 | 45 mm | 47 mm |
| Impact 8 | 47 mm | 49 mm |
| Impact 9 | 59 mm | 55 mm |
| Impact 10 | 74 mm | 58 mm |
| Impact 11 | 86 mm | 61 mm |
| Impact 12 | 100 mm | 63 mm |
| Impact 13 | 120 mm | 64 mm |
| Impact 14 | — | 77 mm |
| Impact 15 | — | 84 mm |
| Imapct 16 | — | 88 mm |
| Impact 17 | — | 91 mm |
| Impact 18 | — | 95 mm |
| Impact 19 | — | 98 mm |
| Impact 20 | — | 100 mm |

After impact 13 on Screen 1, the part of the edge of the mesh had pulled out of the frame and opened a gap with a height of 260 mm and a width of 50 mm, sufficient to allow a probe in to unlock a security door, and therefore ending the test.

The results show that the two screens appeared to have a similar performance for the first 8 impacts at 100 J, but after the impact energy was increased to 200 J for impacts 9 to 13, the first screen experienced much larger deformations than the second screen and failed after impact 13.

In contrast, the second screen with the screen frame element 300—which has an anchoring member closer to the seat (pivot region substantially opposite seat) and having a more acute initial angle—performed much better than the first screen (with screen element 600), with less deflection and deformation after 13 similar impacts. The second screen was then impacted further with a higher impact energy of 300 J for impacts 14 to 20, and still did not fail.

1. A screen frame element comprising an elongate body defining:
a base;
a first flange extending away from the base and defining a first support surface;
a second flange extending away from the base and defining a second support surface opposite the first support surface;
a channel defined between the first and second flanges, the channel extending substantially the length of the body and configured to receive a folded edge of a screen sheet;
an anchoring member extending at least partially along and in parallel with the channel, the anchoring member being connected to the second flange by a deformable pivot region and extending into the channel towards the base and away from the second support surface at an acute angle relative to the first support surface; and
a seat defined by part of the first flange at an inner edge of the first supporting surface substantially opposite the pivot region,
wherein the anchoring member is configured to engage the folded edge of the screen sheet when inserted in the channel and over the anchoring member, such that,
when the screen sheet is drawn away from the base, the anchoring member resists withdrawal of the folded edge of the screen sheet from the channel, and
when the screen sheet is drawn away from the base with sufficient force to overcome a yield strength of the pivot region, with the force on the screen sheet being transmitted to the anchoring member by the folded edge of the screen sheet, the anchoring member is configured to rotate about the pivot region and towards the seat to resist removal of the folded edge of the screen sheet from the channel by gripping part of the screen sheet between the anchoring member and the seat.

2. The screen frame element of claim 1, wherein the seat is located within 2 mm of an imaginary plane extending through the pivot region perpendicular to the first support surface and a direction along the length of the channel.

3. The screen frame element of claim 1, wherein the seat is located directly opposite the pivot region.

4. The screen frame element of claim 1, wherein a width of the anchoring member, defined between the pivot region and a free edge of the anchoring member, is less than a distance between the pivot region and the seat.

5. The screen frame element of claim 1, wherein a thickness of the anchoring member is greater than a thickness of the pivot region.

6. The screen frame element of claim 1, wherein an initial angle of the anchoring member, relative to the first support surface, is less than 60 degrees.

7. The screen frame element of claim 1, wherein the anchoring member comprises a substantially rectangular strip.

8. The screen frame element of claim 1, wherein the anchoring member extends substantially the entire length of the channel.

9. The screen frame element of claim 1, wherein the first and second flanges, the base and the anchoring member define a constant cross-sectional profile along substantially the entire length of the channel.

10. The screen frame element of claim 1, wherein the first and second flanges, the base and the anchoring member are integrally formed.

11. A screen frame kit, comprising:
one or more ones of the screen frame element of claim 1; and
a screen sheet defining one or more folded edges configured to engage the anchoring member of each of the one or more screen frame elements.

12. The screen frame kit of claim 11, further comprising one or more elongate wedges, each configured to be inserted between the screen sheet and the second support surface of each of the one or more screen frame elements to clamp the screen sheet in the channel of each of the one or more screen frame elements.

13. The screen frame kit of claim 12, further comprising one or more isolators configured to isolate the screen sheet from each of the one or more screen frame elements.

14. A method of assembling a screen using the kit of claim 13, the method comprising:
inserting one of the folded edges of the screen sheet into the channel of one of the screen frame elements with part of the folded edge located between the anchoring member and the base of the screen frame element.

15. The method of claim 14, further comprising inserting one of the wedges between the screen sheet and the second support surface of the screen frame element.

16. The method of claim 14, further comprising inserting one of the isolators into the channel of the screen frame element prior to inserting the folded edge of the screen sheet into the screen frame element.

17. A screen formed according to the method of claim 14.

18. A screen comprising a screen frame element according to claim 1.

19. A door comprising a screen according to claim 18.

20. A window comprising a screen according to claim 18.
